(19) United States
(12) Patent Application Publication
(10) Pub. No.: US 2008/0047161 A1
(43) Pub. Date: Feb. 28, 2008

(54) Semiconductor drying process apparatus

(76) Inventors: Yu Fei Goh, Singapore (SG); Zhen Qing Lu, Singapore (SG); Zhi Hong Yi, Singapore (SG); Beng Lark Lee, Singapore (SG)

Correspondence Address: GOODWIN PROCTER L.L.P, 599 LEXINGTON AVE., NEW YORK, NY, 10022, US

(21) Appl. No.: 11/509,156

(22) Filed: Aug. 24, 2006

(51) Int. Cl. F26B 3/00

(52) U.S. Cl. 34/351; 34/468

(57) ABSTRACT

A semiconductor drying process apparatus comprising a processing chamber; two or more inlet/outlet openings formed in the processing chamber; a first pipe member coupled in fluid communication between one or more of the inlet/outlet openings of the processing chamber and a first drain valve; a second pipe member coupled in fluid communication between one or more other ones of the inlet/outlet openings of the processing chamber and a first supply valve; and wherein the first pipe member is coupled in fluid communication to the second pipe member for increasing the flow capacity of the semiconductor drying process apparatus.

### FIELD OF INVENTION

The present invention relates broadly to a semiconductor drying process apparatus, to a method for increasing a flow capacity of a semiconductor drying process apparatus, and to a pipe system for increasing a flow capacity of a semiconductor drying process apparatus, such as but not limited to a Marangoni Dryer.

### BACKGROUND

In the semiconductor wafer fabrication industry, silicon wafers are typically processed, inter alia, in a dryer apparatus, such as a Marangoni dryer. The dryer apparatus is typically capable of supplying and draining liquids such as deionised water (DIW) when processing the wafers. The process tank of the current dryer apparatus is typically provided with one DIW supply line and one DIW drain line. The supply line and the drain line are typically connected to a dedicated supply hole and a dedicated drain hole respectively of the process tank.

Silicon wafers are typically processed in a process tank of the dryer apparatus using a recipe of wafer processing steps. A movable dome comprising one or more inlets for supplying nitrogen gas (N₂) as a carrier gas for isopropyl alcohol (IPA) is typically provided on top of the process tank as a cover for the process tank.

To start processing the wafers, the dome is moved sideways to open the process tank for positioning of the wafers. The wafers are positioned vertically in wafer slots in a wafer stand of a wafer lifter in the process tank. The dome also comprises corresponding wafer slots in the dome underside that are used to secure the wafers when the wafers are lifted to their highest position by the wafer lifter. The positioning of the wafers on the wafer stand is carried out using a robot transfer arm. After positioning the wafers on the wafer stand, the dome is moved sideways to close the process tank.

The recipe of wafer processing steps typically comprises a rinsing step of rinsing the wafers using a high flow supply of deionised water (DIW) using a supply inlet. The rinsing step is used to remove potential minute chemical residue on the wafers. During the rinsing step, the process tank is filled to an overflow and the overflow is observed when DIW flows over the edges of the process tank. The duration of the overflow is typically controlled based on the recipe. The rinsing step is followed by a first drying step of drying the wafers. During the first drying step, the DIW supply is switched to a low flow and a constant flow supply of IPA carried by the carrier gas N₂ is supplied onto the DIW and wafers surfaces. The wafers are lifted through the DIW surface using the wafer lifter at a “normal” speed setting. The IPA carried by N₂ onto the DIW and wafers surfaces creates a difference in the surface tensions of the water surface and the wafer surfaces giving rise to the so-called Marangoni dryer effect. The difference in the surface tensions when the wafers are lifted from the water surface removes water from the wafer surfaces. The process margin of water removal from the wafer surfaces is proportional to the lifting speed. At a point just before the wafers are completely lifted out from the water surface, the wafer lifter speed is lowered to ensure an adequate margin for removing water at the bottom edges of the wafers leaving the water. Thus, the first drying step is followed by a second drying step of drying the wafer that maintains the low flow supply of DIW together with the constant flow supply IPA and N₂ while lifting the wafers using the wafer lifter at a “low” speed setting. A sensor is provided in the system to set a point where the wafer lifter reaches the water surface. At that point, the sensor activates a lifter knife on the wafer lifter to separate the wafers from the wafer stand of the wafer lifter and lift the wafers out of the DIW surface completely. The lifter knife uses a minimal contact surface to lift the wafers to prevent water entrapment under the wafers. At this stage, the wafers are supported by the lifter knife and secured by the corresponding wafer slots in the dome underside. Therefore, the dome cannot be moved to prevent damage to the wafers.

The wafers surfaces drying process is considered stopped or completed when the wafers are completely lifted out from the water surface. The second drying step is followed by a draining step of draining the DIW. During the draining step, the flow supply of IPA and N₂ is maintained while the supply of DIW is stopped and a drain valve of the process tank is opened to drain the DIW. The DIW is drained out before transferring the wafers out of the process tank so that the risk of the wafers becoming wet again during transferring is lowered. The draining step is followed by a robot transfer step. The robot transfer step comprises stopping the supply of IPA and N₂ and closing the drain valve. To open the dome, the wafers are lowered by first lowering the lifter knife and then lowering the wafer lifter to its lowest position. The dome is then moved sideways to open the process tank and the wafers are transferred out of the process tank using the robot transfer arm.

Based on the above recipe, in order to improve the processing speed of drying the silicon wafers (ie. wafers processed per hour), one solution is to increase the draining capacity of the dryer apparatus. Increasing the draining capacity typically reduces the draining time of the DIW. The faster the DIW is drained from the dryer apparatus, the faster the wafers may be transferred out of the dryer apparatus and therefore, more wafers may be processed per unit time. One method of increasing the draining capacity of the dryer apparatus is to provide an additional drain line to the process tank. The additional drain line may be provided by drilling a hole that is of a bigger diameter to the existing drain hole on the process tank and mounting a drain pipe to the drilled hole.

One problem that may arise when drilling the additional hole is that drilling operations in a semiconductor fabrication plant typically degrades particle performance and increases cross contamination in the wafers drying system. The cross contamination and degradation in particle performance may be due to factors such as transporting the pipe, drilling the hole, welding the pipe to the hole and other installation works that may degrade the original state of the high purity characteristic of process tank material. Any minute defect or cross contaminant in the wafers drying system may lead to non-perfect wafers surface conditions that may degrade product performance.

Another solution to improve the processing speed of silicon wafers is to increase the wafer lifter speed at the second drying step and thus, beginning the draining step sooner. However, one problem that may arise from increasing the wafer lifter speed is that the drying process margin may be reduced, resulting in the wafers not being completely dry when the draining process is concluded and when the wafers are transferred from the process tank at the robot transfer step.

In view of the above problems, there exists a need to provide a pipe system and method for increasing a flow capacity of a semiconductor processing apparatus to address at least one of the problems.

### SUMMARY

In accordance with a first aspect of the present invention, there is provided a semiconductor drying process apparatus comprising a processing chamber; two or more inlet/outlet openings formed in the processing chamber; a first pipe member coupled in fluid communication between one or more of the inlet/outlet openings of the processing chamber and a first drain valve; a second pipe member coupled in fluid communication between one or more other ones of the inlet/outlet openings of the processing chamber and a first supply valve; and wherein the first pipe member is coupled in fluid communication to the second pipe member for increasing the flow capacity of the semiconductor drying process apparatus.

In a supply configuration, the first supply valve may be opened and the first drain valve may be closed, and in a drain configuration, the first drain valve may be opened and the first supply valve may be closed.

The first or second pipe members may comprise an opening for coupling in fluid communication to a second drain valve, the second drain valve may have a cross-section smaller than that of the first drain valve, for providing a slow drain configuration in which the first drain valve may be closed, the second drain valve may be opened, and the supply valve may be closed.

In the supply configuration, the first supply valve may be opened and the first and second drain valves may be closed.

The second pipe member may comprise one or more first coupling members for removably coupling to the inlet/outlet openings and a second coupling member for removably coupling to the first supply valve.

The first pipe member may comprise one or more third coupling members for removably coupling to the inlet/outlet openings and a fourth coupling member for removably coupling to the first drain valve.

The first supply valve may be configured for coupling in fluid communication to a second and a third supply valve respectively, for providing a fast supply configuration in which the first and second supply valves may be opened and the drain valve or valves may be closed, and a slow supply configuration in which the first and third supply valves may be opened and the drain valve or valves may be closed.

The second supply valve may be coupled in fluid communication to a high flow source, and the third supply valve may be coupled in fluid communication with a low flow source.

The high flow source and the low flow source may be different sources or the same source.

In accordance with a second aspect of the present invention, there is provided a method for increasing a flow capacity of a semiconductor drying process apparatus, the method comprising providing fluid communication between one or more existing inlet/outlet openings of the semiconductor drying process apparatus and a first drain valve using a first pipe member; providing fluid communication between one or more other existing inlet/outlet openings of the semiconductor drying process apparatus and a first supply valve using a second pipe member; and providing fluid communication between the first pipe member and the second pipe member to increase the flow capacity of the semiconductor drying process apparatus.

In a supply configuration, the first supply valve may be opened and the first drain valve may be closed, and in a drain configuration, the first drain valve may be opened and the first supply valve is closed.

The first or second pipe members may comprise an opening for coupling in fluid communication to a second drain valve, the second drain valve may have a cross-section smaller than that of the first drain valve, for providing a slow drain configuration in which the first drain valve may be closed, the second drain valve may be opened, and the supply valve may be closed.

In the supply configuration, the first supply valve may be opened and the first and second drain valves may be closed.

The second pipe member may be removably coupled to the inlet/outlet openings and to the first supply valve.

The first pipe member may be removably coupled to the inlet/outlet openings and to the first drain valve.

The method may comprise coupling the first supply valve to the second pipe member, and coupling the first supply valve in fluid communication to a second and a third supply valve respectively, for providing a fast supply configuration in which the first and second supply valves may be opened and the drain valve or valves may be closed, and a slow supply configuration in which the first and third supply valves may be opened and the drain valve or valves may be closed.

The second supply valve may be coupled in fluid communication to a high flow source, and the third supply valve may be coupled in fluid communication with a low flow source.

The high flow source and the low flow source may be different sources or the same source.

In accordance with a third aspect of the present invention, there is provided a pipe system for increasing a flow capacity of a semiconductor drying process apparatus, the pipe system comprising a first pipe member for coupling in fluid communication between one or more existing inlet/outlet openings of the semiconductor drying process apparatus and a first drain valve; a second pipe member for coupling in fluid communication between one or more other existing inlet/outlet openings of the semiconductor drying process apparatus and a first supply valve; and wherein the first pipe member is coupled in fluid communication to the second pipe member for increasing the flow capacity of the semiconductor drying process apparatus.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 (a) is a schematic perspective-view drawing of a typical dryer apparatus.

FIG. 1(b) is a schematic layout drawing of a typical Marangoni drying apparatus piping system.

FIG. 2 is a schematic layout drawing of a drying process apparatus piping system incorporating a drain/supply pipe system.

FIG. 3 is a schematic drawing illustrating the drain/supply pipe system being used during a drain-mode operation.

FIG. 4 is a schematic drawing illustrating the drain/supply pipe system being used during a supply-mode operation.

FIG. 5 is a schematic drawing illustrating the dimensions of the drain/supply pipe system.

FIG. 6 is a schematic drawing illustrating one method of constructing the drain/supply pipe system using off-the-shelf parts.

FIG. 7 is a flowchart illustrating a method for increasing a flow capacity of a semiconductor drying process apparatus.

### DETAILED DESCRIPTION

In the description below, an overview of a typical semiconductor processing apparatus, such as a dryer apparatus, and a typical drying apparatus piping system is first provided for better understanding followed by a detailed description of an example embodiment of the invention.

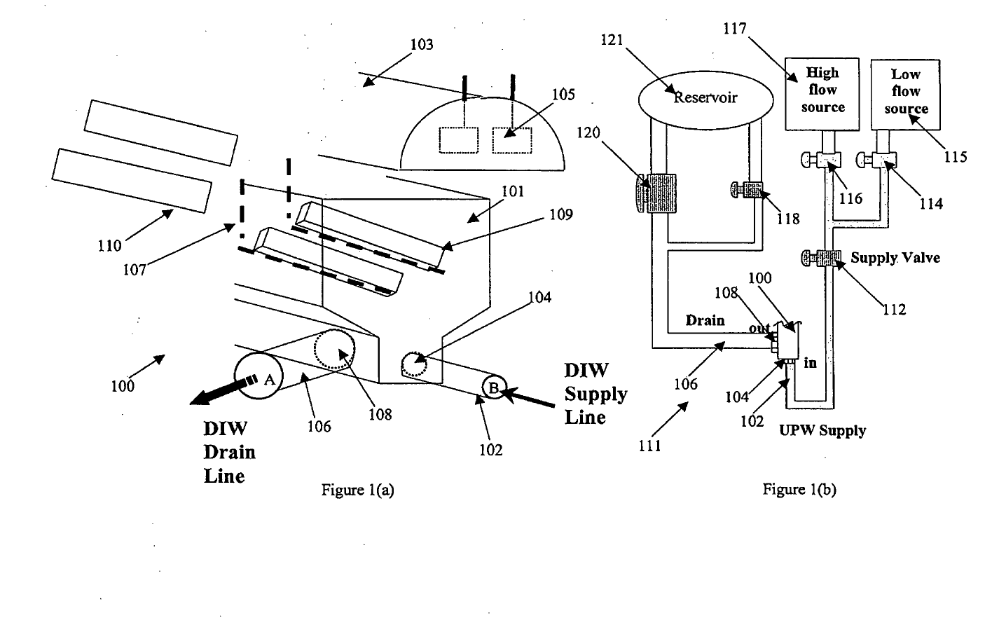

FIG. 1(a) is a schematic perspective-view drawing of the typical dryer apparatus 100. The dryer apparatus 100 comprises a processing chamber 101 having a DIW supply line 102 coupled to a supply inlet 104 and a DIW drain line 106 coupled to a drain outlet 108. A movable dome 103 is provided above the processing chamber 101 and is movable sideways to open or close the processing chamber 101. The dome 103 comprises inlets e.g. 105 for supplying IPA and the carrier gas N₂. The dome 103 underside further comprises wafer slots (not shown) to secure wafers (not shown) when the wafers (not shown) are lifted to their highest position in the processing chamber 101. A wafer lifter 107 is provided for lifting/lowering the wafers (not shown) in a vertical direction. The wafers (not shown) are positioned vertically on wafer slots of a wafer stand 109 of the wafer lifter 107. The wafers (not shown) may be separated from the wafer stand 109 by a lifter knife (not shown). A robot transfer arm 110 is provided to position the wafers (not shown) on the wafer stand 109 prior to processing. The robot transfer arm 110 is also used to remove the wafers (not shown) from the processing chamber 101 after draining DIW from the processing chamber 101 and after the dome 103 is moved sideways away from processing chamber 101.

For ease of illustration, the dome 103, the inlets e.g. 105, the wafer lifter 107, wafer stand 109 and the robot transfer arm 110 are not reproduced in the subsequent figures of the description.

Referring to the processing chamber 101, the diameters for the DIW supply line 102 and the DIW drain line 106 are about 1 inch and 1.5 inches respectively. Thus, the flow surface areas of the DIW supply line 102 and the DIW drain line 106 are determined as follows:

Surface Area=π.r² (1)

### Therefore, the surface area A of the DIW drain line 106 is,

$$\begin{matrix}A = {π ( 1.5 / 2 )}^{2} \\ = {π ( 0.75 )}^{2} {inches}^{2} \\ = 0.56 π {inches}^{2}\end{matrix} \qquad ( 2 )$$

### The surface area B of the DIW supply line 102 is,

$$\begin{matrix}B = {π ( 1 / 2 )}^{2} \\ = {π ( 0.5 )}^{2} {inches}^{2} \\ = 0.25 π {inches}^{2}\end{matrix} \qquad ( 3 )$$

FIG. 1(b) is a schematic layout drawing of a typical drying apparatus piping system 111. To supply DIW to the dryer apparatus 100, the DIW supply line 102 is coupled to a supply valve 112 and the supply is “switched” on/off by opening or closing the supply valve 112 respectively. The flow rate of the DIW supply is controllable by using a low flow control valve 114, a high flow control valve 116 or both. The low flow control valve 114 is coupled to a low flow source 115 and the high flow control valve 116 is coupled to a high flow source 117. To drain the DIW from the dryer apparatus 100, the DIW drain line 106 is coupled to a slow drain valve 118 and a fast drain valve 120. Depending on the drain rate desired, the slow drain valve 118, the fast drain valve 120 or both may be opened. The drain valves 118, 120 are coupled to a reservoir 121 for collection of the drained liquid. During a supply-mode operation, the drain valves 118, 120 are kept closed while during a drain-mode operation, the supply valve 112 is kept closed.

Following the above brief discussion of the typical dryer apparatus and the typical drying apparatus piping system, the example embodiment will now be described in detail. Increasing the draining capacity of the dryer apparatus 100 may reduce the processing time of silicon wafers in the dryer apparatus 100 since the silicon wafers are transferred out sooner from the dryer apparatus 100. Therefore, the speed of processing silicon wafers may increase since more wafers are processed per unit time.

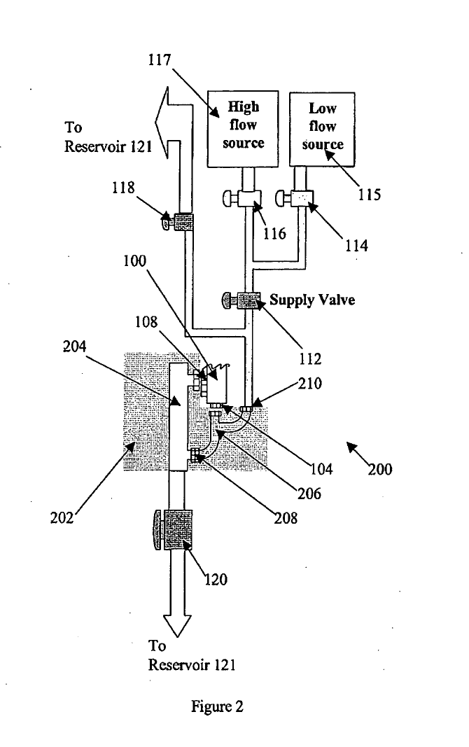

FIG. 2 is a schematic layout drawing of a drying process apparatus piping system 200 incorporating a drain/supply pipe system 202. The drain/supply pipe system 202 comprises a drain-hole pipe member 204 and a supply-hole pipe member 206. The drain-hole pipe member 204 and the supply-hole pipe member 206 are removably coupled (see numeral 208) to each other using mating pipe connectors. The drain-hole pipe member 204 is removably coupled to the drain outlet 108 of the dryer apparatus 100 using mating pipe connectors and to the fast drain valve 120. Similarly, the supply-hole pipe member 206 is removably coupled to the supply inlet 104 of the dryer apparatus 100 using mating pipe connectors. The supply-hole pipe member 206 is also removably connected (see numeral 210) to the supply valve 112 and to the slow drain valve 118. The slow drain valve 118 may alternatively be coupled to the drain-hole pipe member 204. The slow drain valve 118 may also be alternatively coupled to any pipe portion along the supply-hole pipe member 206 or any pipe portion bounded by the supply-hole pipe member 206 and the supply valve 112.

It would be appreciated by a person skilled in the art that the drain/supply pipe system 202 may be removable when desired and may be viewed as a kit for use when increased draining capacity is desired. The effect of using the drain/supply pipe system 202 in connection with the dryer apparatus 100 is described below.

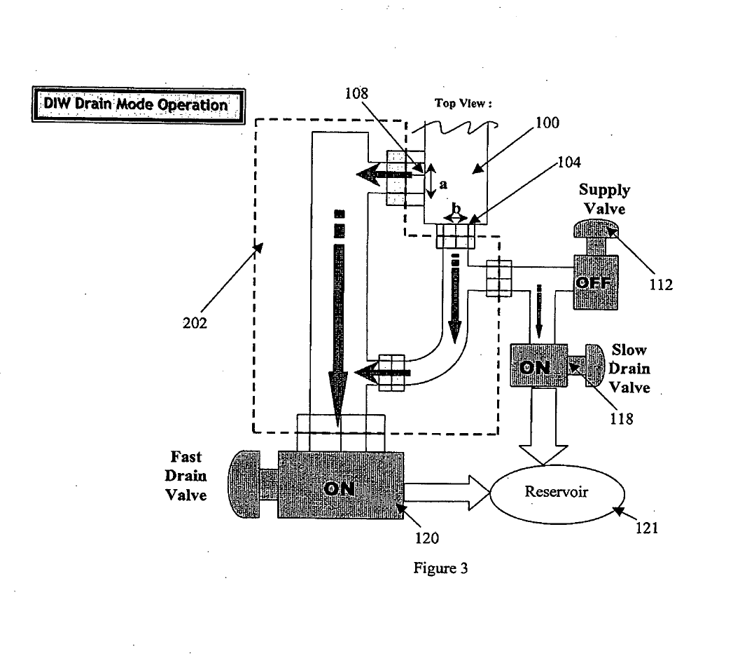

FIG. 3 is a schematic drawing illustrating the drain/supply pipe system 202 of FIG. 2 being used during a drain-mode operation. During the drain-mode operation, the supply valve 112 is closed and both the slow drain valve 118 and the fast drain valve 120 are opened. Therefore, DIW is drained from the dryer apparatus 100 via both the drain outlet 108 and the supply inlet 104 to both opened drain valves 118, 120. This is in contrast to the draining operation of the system in FIG. 1(b) where DIW is drained from the dryer apparatus 100 via only the dedicated drain outlet 108.

Therefore, when both drain valves 118, 120 are opened, the effective draining surface area of the dryer apparatus 100 is approximately the sum of the surface area results from equations (2) and (3). In the current arrangement, the effective draining surface area is about (0.56π+0.25π) inches² or about 0.81 πinches². Assume that flow rate is calculated as (surface area Xτ), where τ is a flow constant. Thus, compared to a flow rate of about 0.56 πτinches² for the typical system in FIG. 1(b) (see equation (2)), the current flow rate of about 0.81 πτinches² is about a 45% increase in the draining capacity of the dryer apparatus 100.

Based on the current arrangement, the drain capacity of the dryer apparatus 100 can be increased by opening both drain valves 118, 120 utilising the existing ports or holes 108, 104, without the need to drill any additional holes in the dryer apparatus 100. Therefore, using the drain/supply pipe system 202, cross contamination and degradation in particle performance in the drying process may be minimised as compared to carrying out drilling operations on the processing chamber 101.

As discussed above, increasing the draining capacity of the dryer apparatus 100 reduces the time taken to drain the DIW from the dryer apparatus 100. The time reduction results in a shorter drain process step when using typical production recipes and may result in more silicon wafers being processed per hour. Using the current arrangement, an estimated wafers per hour (WPH) improvement of about 5-10% on average is achieved.

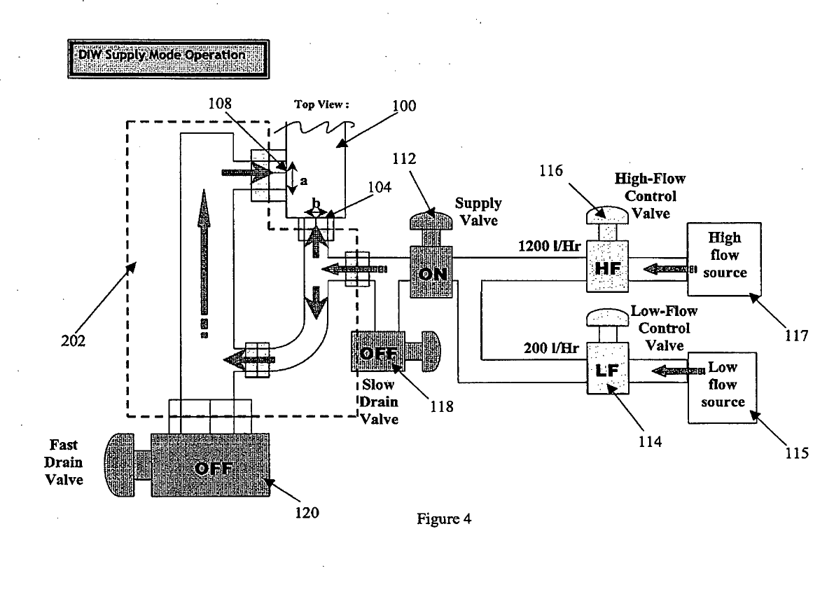

Although DIW is drained away faster during the drain-mode operation, the supply flow rate of DIW into the dryer apparatus 100 during a supply-mode operation is maintained at the original recipe supply flow rate by controlling the flow control valves 114, 116 (FIG. 2). FIG. 4 is a schematic drawing illustrating the drain/supply pipe system 202 of FIG. 2 being used during a supply-mode operation. During the supply-mode operation, the slow drain valve 118 and the fast drain valve 120 are closed. On the other hand, the supply valve 112, the low flow control valve 114 and the high flow control valve 116 are adjusted to allow DIW to flow into the dryer apparatus 100 via the drain outlet 108 and the supply inlet 104. The flow rates of the low flow control valve 114 and the high flow control valve 116 are maintained at about 200 litres per hour and about 1200 litres per hour respectively. As the flow rates of the low flow control valve 114 and the high flow control valve 116 are adjustable and controllable (ie. by litres per hour), the supply flow rate of DIW to the dryer apparatus 100 during the supply-mode operation is maintained at a constant flow to the supply flow rate of the system in FIG. 1(b), after taking into account the increase in the effective flow surface area to about 0.81 πinches².

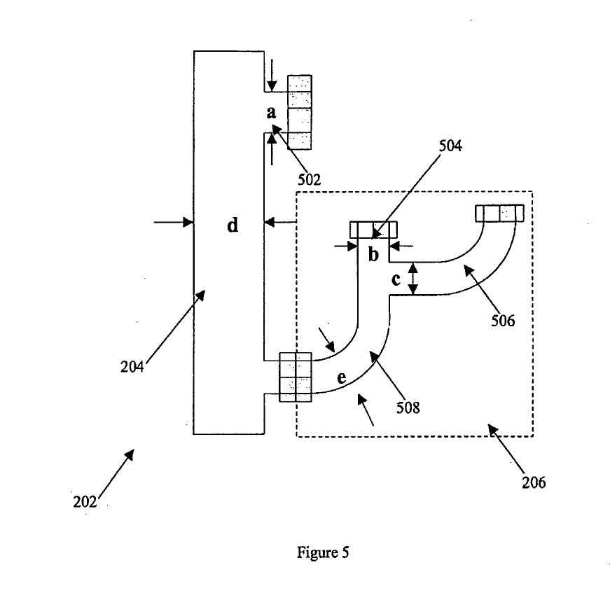

FIG. 5 is a schematic drawing illustrating the dimensions of the drain/supply pipe system 202 in the current arrangement. The diameter a of a first pipe opening 502 is about 1.5 inches, the diameter b of a second pipe opening 504 is about 0.75 to 1 inch, the diameter c of a pipe portion 506 connecting the supply-hole pipe member 206 to the supply valve 112 (not shown) is about 0.5 to 1 inch, the diameter d of the drain-hole pipe member 204 is about 1.5 to 4 inches and the diameter e of a pipe portion 508 connecting the supply-hole pipe member 206 to the drain-hole pipe member 204 is about 0.75 to 2 inches. In the current arrangement, the material used to form the drain/supply pipe system 202 is high purity PolyVinylidine DiFluoride (PVDF). Alternatively, other high purity materials (eg. Teflon) may be used as a substitute for PVDF.

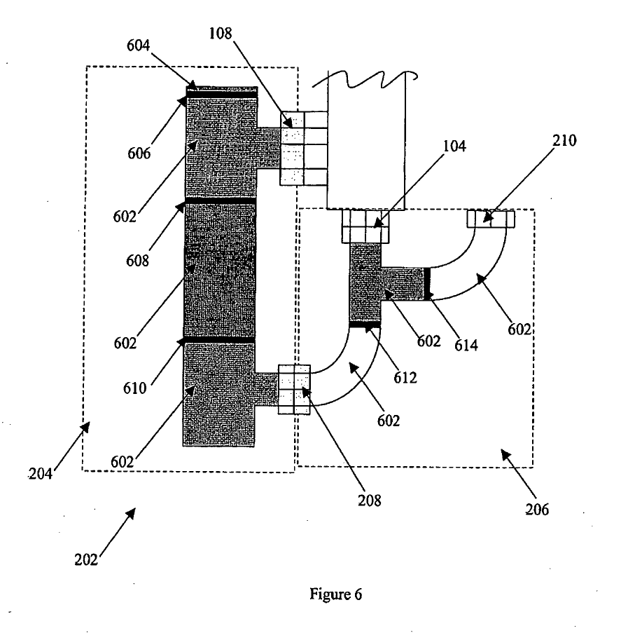

FIG. 6 is a schematic drawing illustrating a construction of the drain/supply pipe system 202 using off-the-shelf parts e.g. 602. In the current arrangement, two welding methods may be used to join various fittings, such as the off-the-shelf parts e.g. 602 and a pipe-end cover 604, permanently together. A first method is to use an Infra Red (IR) PVDF welding tool for IR welding and a second method is to use a PVDF welding rod in conjunction with a manual portable welding gun. The permanent joints in the current arrangement are indicated at numerals 606, 608, 610, 612 and 614. Non-permanent joints indicated at numerals 108, 208, 104 and 210 for joining the various parts are based on union fitting. Referring to FIG. 3, the fast drain valve 120 may be coupled to the drain/supply pipe system 202 by using either one of the above welding methods or using union fitting.

It would be appreciated by a person skilled in the art that manufacturing the drain/supply pipe system is not limited to joining pipe portions using the above welding methods or union fitting and may include other manufacturing methods such as cast moulding of joints.

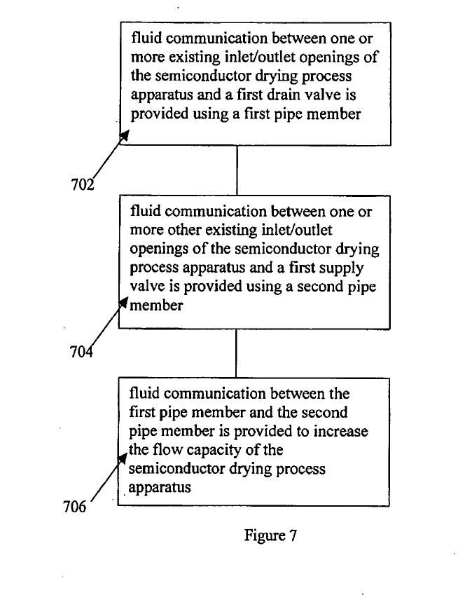

FIG. 7 is a flowchart illustrating a method for increasing a flow capacity of a semiconductor drying process apparatus. At step 702, fluid communication between one or more existing inlet/outlet openings of the semiconductor drying process apparatus and a first drain valve is provided using a first pipe member. At step 704, fluid communication between one or more other existing inlet/outlet openings of the semiconductor drying process apparatus and a first supply valve is provided using a second pipe member. At step 706, fluid communication between the first pipe member and the second pipe member is provided to increase the flow capacity of the semiconductor drying process apparatus.

In the above arrangement, as no additional intrusion or drilling works is carried out on the dryer apparatus, particle performance of the drying process may be maintained and cross contamination may be kept to a minimum. In addition, using the drain/supply pipe system instead of drilling additional holes in the dryer apparatus, the upgrade kits can be pre-fabricated, and production window may be reduced from about two days to about one hour. The after-installation treatment of the drain/supply pipe system may also be kept to a minimum by carrying out a pre-flush since contamination may be minimal. Also, by using the drain/supply pipe system, the modifications are external to the chamber of the dryer apparatus and the dryer apparatus may be operated without additionally calibrating the wafer stand reference in the dryer apparatus. Also, the robot chuck for lifting wafers in the dryer apparatus may be operated without additional calibration. Furthermore, the drying process margin is not affected in the current arrangement and the wafers in the drying apparatus are completely dry before the draining process step. In addition, the current arrangement may be adapted for connection and for use with other dryer apparatuses or other process applications tanks or systems.

It would be appreciated by a person skilled in the art that the above arrangement is not limited to supplying and draining DIW and may be applicable to supplying and draining other solvents, liquid or chemicals.

In addition, it would be appreciated that the drain/supply pipe system is not limited to being removably connected to the dryer apparatus and may be permanently attached to the dryer apparatus.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A semiconductor drying process apparatus comprising
a processing chamber;
two or more inlet/outlet openings formed in the processing chamber;
a first pipe member coupled in fluid communication between one or more of the inlet/outlet openings of the processing chamber and a first drain valve;
a second pipe member coupled in fluid communication between one or more other ones of the inlet/outlet openings of the processing chamber and a first supply valve; and
wherein the first pipe member is coupled in fluid communication to the second pipe member for increasing the flow capacity of the semiconductor drying process apparatus.

2. The semiconductor drying process apparatus as claimed in claim 1, wherein in a supply configuration, the first supply valve is opened and the first drain valve is closed, and in a drain configuration, the first drain valve is opened and the first supply valve is closed.

3. The semiconductor drying process apparatus as claimed in claim 1, wherein the first or second pipe members comprise an opening for coupling in fluid communication to a second drain valve, the second drain valve having a cross-section smaller than that of the first drain valve, for providing a slow drain configuration in which the first drain valve is closed, the second drain valve is open, and the supply valve is closed.

4. The semiconductor drying process apparatus as claimed in claim 3, wherein in the supply configuration, the first supply valve is opened and the first and second drain valves are closed.

5. The semiconductor drying process apparatus as claimed in claim 1, wherein the second pipe member comprises one or more first coupling members for removably coupling to the inlet/outlet openings and a second coupling member for removably coupling to the first supply valve.

6. The semiconductor drying process apparatus as claimed in claim 5, wherein the first pipe member comprises one or more third coupling members for removably coupling to the inlet/outlet openings and a fourth coupling member for removably coupling to the first drain valve.

7. The semiconductor drying process apparatus as claimed in claim 1, wherein the first supply valve is configured for coupling in fluid communication to a second and a third supply valve respectively, for providing a fast supply configuration in which the first and second supply valves are opened and the drain valve or valves are closed, and a slow supply configuration in which the first and third supply valves are opened and the drain valve or valves are closed.

8. The semiconductor drying process apparatus as claimed in claim 7, wherein the second supply valve is coupled in fluid communication to a high flow source, and the third supply valve is coupled in fluid communication with a low flow source.

9. The semiconductor drying process apparatus as claimed in claim 8, wherein the high flow source and the low flow source are different sources or the same source.

10. A method for increasing a flow capacity of a semiconductor drying process apparatus, the method comprising
providing fluid communication between one or more existing inlet/outlet openings of the semiconductor drying process apparatus and a first drain valve using a first pipe member;
providing fluid communication between one or more other existing inlet/outlet openings of the semiconductor drying process apparatus and a first supply valve using a second pipe member; and
providing fluid communication between the first pipe member and the second pipe member to increase the flow capacity of the semiconductor drying process apparatus.

11. The method as claimed in claim 10, wherein in a supply configuration, the first supply valve is opened and the first drain valve is closed, and in a drain configuration, the first drain valve is opened and the first supply valve is closed.

12. The method as claimed in claim 10, wherein the first or second pipe members comprise an opening for coupling in fluid communication to a second drain valve, the second drain valve having a cross-section smaller than that of the first drain valve, for providing a slow drain configuration in which the first drain valve is closed, the second drain valve is opened, and the supply valve is closed.

13. The method as claimed in claim 12, wherein in the supply configuration, the first supply valve is opened and the first and second drain valves are closed.

14. The method as claimed in claim 10, wherein the second pipe member is removably coupled to the inlet/outlet openings and to the first supply valve.

15. The method as claimed in any one of claim 10, wherein the first pipe member is removably coupled to the inlet/outlet openings and to the first drain valve.

16. The method as claimed in any one of claim 10, comprising coupling the first supply valve to the second pipe member, and coupling the first supply valve in fluid communication to a second and a third supply valve respectively, for providing a fast supply configuration in which the first and second supply valves are opened and the drain valve or valves are closed, and a slow supply configuration in which the first and third supply valves are opened and the drain valve or valves are closed.

17. The method as claimed in claim 16, wherein the second supply valve is coupled in fluid communication to a high flow source, and the third supply valve is coupled in fluid communication with a low flow source.

18. The method as claimed in claim 17, wherein the high flow source and the low flow source are different sources or the same source.

19. A pipe system for increasing a flow capacity of a semiconductor drying process apparatus, the pipe system comprising
a first pipe member for coupling in fluid communication between one or more existing inlet/outlet openings of the semiconductor drying process apparatus and a first drain valve;
a second pipe member for coupling in fluid communication between one or more other existing inlet/outlet openings of the semiconductor drying process apparatus and a first supply valve; and
wherein the first pipe member is coupled in fluid communication to the second pipe member for increasing the flow capacity of the semiconductor drying process apparatus.
